(19) United States
(12) Patent Application Publication
(10) Pub. No.: US 2006/0100935 A1
(43) Pub. Date: May 11, 2006

(54) Method of payment for mobile platform network access

(76) Inventors: Dan Klawitter, Renton, WA (US); Ed Mitchell, West Linn, OR (US)

Correspondence Address: HARNESS, DICKEY & PIERCE, P.L.C., P.O. BOX 828, BLOOMFIELD HILLS, MI, 48303, US

(21) Appl. No.: 10/985,170

(22) Filed: Nov. 10, 2004

(51) Int. Cl. G06Q 99/00; G06Q 30/00

(52) U.S. Cl. 705/26; 705/1

(57) ABSTRACT

A method is provided for authorizing a mobile platform passenger to use his/her affinity program merit points to pay for access to services provided by a mobile platform communication system. The method includes communicating an authentication request message from the mobile platform communication system to an affinity program authentication Web service. An authentication status message is then communicated from the affinity program authentication Web service to the mobile platform communication system indicating whether the mobile platform passenger is an affinity program member. If the mobile platform passenger is verified to be an affinity program member, a debit authorization request message is communicated from the mobile platform communication system to an affinity program debit authorization Web service. The affinity program debit authorization Web service then communicates a debit authorization status message to the mobile platform communication system. The debit authorization status message indicates whether the affinity program member is authorized to pay for accessing the services provided by the mobile platform communication system using affinity program award points.

### FIELD OF INVENTION

The invention relates generally to entertainment and information services provided to passengers of a mobile platform. More particularly, the present invention relates to payment options made available to mobile platform passengers for access to such services.

### BACKGROUND OF THE INVENTION

In today's world of high-tech communications, mobile platform carriers often offer their passengers services that provide access to entertainment media, information resources and other electronic data via complex communication systems that provide Internet access. Generally, such mobile platform communication systems include an on-board local area network (LAN) wirelessly connected, via satellite or any other suitable wireless communication means, to a base station network, e.g. a LAN or wide area network (WAN), whereby Internet access is established. One such communication system is described in pending U.S. patent application Ser. No. 09/639,912, titled, Method And Apparatus For Providing Bi-Directional Data Services And Live Television Programming To Mobile Platforms, filed Aug. 16, 2000, and assigned to the Boeing Co, which is herein incorporated in its entirety.

These types of on-board communication services are typically provided to passengers of the mobile platform at a cost to the user, i.e. the passenger desiring to access the services. At least some known mobile platform carriers allow their passengers to pay for these services either in advance of boarding the mobile platform or using a credit or debit card once on-board the mobile platform. These payment methods are generally convenient for passengers that have time to plan and pay for using such services in advance, or that desire to use a credit or debit card. However, the currently known payment options are not always convenient for all passengers. Therefore, in efforts to provide more convenience to their passengers, mobile platform carriers find it desirable to provide as many payment options for such services as possible. Thus, it is desirable to provide other convenient payment options for mobile platform passengers to utilize on-board communication system, e.g. on-board LANs.

### BRIEF SUMMARY OF THE INVENTION

One preferred embodiment of the present invention provides a method for authorizing a mobile platform passenger to use his/her affinity program merit points to pay for access to services provided by a mobile platform communication system. The method includes communicating an authentication request message from the mobile platform communication system to an affinity program authentication Web service. The authentication request message requests verification that the mobile platform passenger is an affinity program member. An authentication status message is then communicated from the affinity program authentication Web service to the mobile platform communication system indicating whether the mobile platform passenger is an affinity program member. If the mobile platform passenger is verified to be an affinity program member, a debit authorization request message is communicated from the mobile platform communication system to an affinity program debit authorization Web service. The debit authorization request message requests authorization for the affinity program member to use his/her affinity program award points to pay for accessing the services provided by the mobile platform communication system. The affinity program debit authorization Web service then communicates a debit authorization status message to the mobile platform communication system. The debit authorization status message indicates whether the affinity program member is authorized to pay for accessing the services provided by the mobile platform communication system using affinity program award points. If the affinity program member is authorized to pay for accessing the services using affinity program award points the mobile platform communication system allows the member to access to the services and his/her affinity program award points account is debited the specified amount of award points by the mobile platform communication system.

Further areas of applicability of the present invention will become apparent from the detailed description provided hereinafter. It should be understood that the detailed description and specific examples, while indicating the preferred embodiments of the invention, are intended for purposes of illustration only and are not intended to limit the scope of the invention. Furthermore, the features, functions, and advantages of the present invention can be achieved independently in various embodiments of the present inventions or may be combined in yet other embodiments.

### BRIEF DESCRIPTION OF THE DRAWINGS

The present invention will become more fully understood from the detailed description and accompanying drawings, wherein;

FIG. 1 is block diagram of a system for authenticating an affinity program member and authorizing debiting of the member's affinity program award points account to pay for access to services provided by a mobile platform communication system, in accordance with a preferred embodiment of the present invention;

FIG. 2 is an illustration of a Web service architecture between a mobile platform communication system and an affinity program provider network, shown in FIG. 1, in accordance with a preferred embodiment of the present invention;

FIG. 3 is a sequence diagram illustrating data flow between a passenger interface, the mobile platform communication system and the affinity program provider network shown in FIG. 1;

FIG. 4 is a table showing exemplary attributes included in an authentication request message communicated within the system shown in FIG. 1;

FIG. 5 is a table showing exemplary attributes that are included in an authentication status message communicated within the system shown in FIG. 1

FIG. 6 is a table showing exemplary attributes that are included in a debit authorization request message communicated within the system shown in FIG. 1;

FIG. 7 is a table showing exemplary attributes that are included in a debit authorization status message communicated within the system shown in FIG. 1;

FIG. 8 is a sequence diagram illustrating data flow between the mobile platform passenger interface, the mobile platform communication system and the affinity program provider network when an authenticated passenger desires to re-logon to the mobile platform communication system;

FIG. 9 is a sequence diagram illustrating data flow between the mobile platform passenger interface, the mobile platform communication system and the affinity program provider network when an authentication Web service denies authentication of the passenger; and

FIG. 10 is a sequence diagram illustrating data flow between the mobile platform passenger interface, the mobile platform communication system and the affinity program provider network when a debit authorization Web service denies debit authorization of an affinity program member.

Corresponding reference numerals indicate corresponding parts throughout the several views of drawings.

### DETAILED DESCRIPTION OF THE INVENTION

FIG. 1 is a block diagram of a system 10 for authenticating an affinity program member and authorizing debiting of an affinity program award points account of the member to pay for access to services provided on-board a mobile platform, e.g. entertainment, information and Internet services. The system 10 includes a mobile platform communication system (MPCS) 14 and an affinity program provider network (APPN) 18. As used herein, an affinity program provider is any company, corporation, business, etc. that awards ‘points’ when a member of the program utilizes the services or purchases the products provided by the company, corporation, business, etc. For example, an affinity program can be a frequent flyer program offered by an airline, or an award points program offered by a credit card company, or a discount dollars program offered by a supermarket. Thus, in these examples the affinity program providers would be the airline, the credit card company and the supermarket.

At least a portion of the MPCS 14 is on-board a mobile platform (not shown) such as an aircraft, bus, train, ship or automobile. In a preferred embodiment, the MPCS 14 includes an on-board network portion that communicates with an off-board network portion, such as the mobile platform communication system described in the pending '912 patent application described above and incorporated by reference herein in its entirety. The MPCS 14 communicates with the APPN 18 to authenticate that a mobile platform passenger requesting to utilize services provided by the MPCS 14, e.g. entertainment, information and Internet services, is an affinity program member. If the passenger is an affinity program member, the MPCS 14 communicates further with the APPN 18 to obtain authorization for the member to pay for access to the services using his/her affinity program award points.

More particularly, to verify that the mobile platform passenger is an affinity program member, the MPCS 14 communicates with a member authentication Web service module 22 of the APPN 18 that provides an authentication Web service. Furthermore, to authorize the member to pay for access to the MPCS services using the member's affinity program award points, the MPCS 14 communicates with a debit authorization Web service module 26 of the APPN 18 that provides a debit authorization Web service. As used herein, a Web service is a piece of business logic, located somewhere on the internet, that is accessible through standard-based internet protocols such as HTTP. More particularly, a Web service is technology used to interface between two businesses so that they can do business together over software where there are different computer network systems on each end, e.g. the MPCS 14 and the APPN 18. A Web service has special behavioral characteristics, for example, the Web service is XML-based, loosely coupled, course-grained, synchronous or asynchronous, supports remote procedure calls (RPCs) and supports document exchange.

In a preferred embodiment, the system 10 implements the use of simple object access protocol (SOAP) and web service description language (WSDL) to communicate between the MPCS 14 and APPN 18, i.e. the authentication Web service and the debit authorization Web service. SOAP provides a packaging structure for transporting XML documents over a variety of internet technologies, including HTTP, SMTP and FTP. SOAP also provides a simple structure for performing RPC invocations using XML for transport. By having a standard transport mechanism the MPCS 14 is interoperable with the APPN 18. That is, it does not matter to the MPCS 14 whether the authentication and debit authorization Web services are implemented with J2EE, .NET, or COBOL. WSDL is an web service technology that describes the interfaces of the authentication and debit authorization Web services in a standardized way using the XML markup language. WSDL standardizes how the authentication and debit authorization Web Services represent the input and output parameters of an invocation externally, the function's structure, the nature of the invocation (in only, in/out, etc.) and the Web service protocol binding. Therefore, WSDL enables the MPCS 14 to automatically understand how to interact with the authentication and debit authorization Web services.

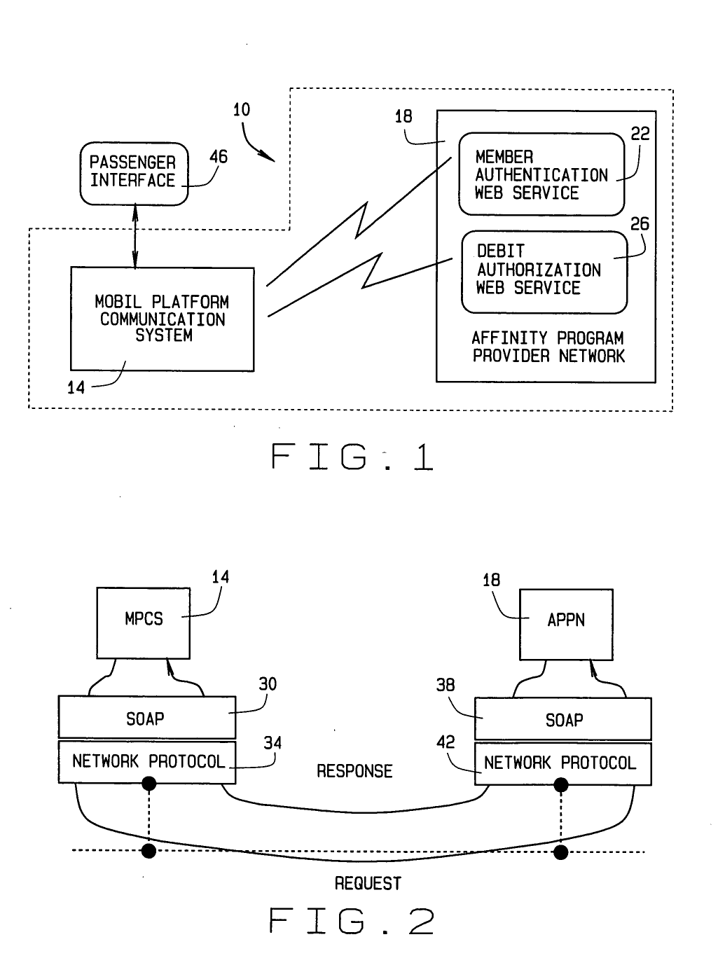

FIG. 2 is an illustration of the Web service architecture between the MPCS 14 and the APPN 18. Generally, the MPCS 14 formulates a request and communicates the request to the APPN 18. When communicating the request to the APPN 18 the request is passed through a first SOAP layer 30 and a first network protocol layer 34 at the MPCS 14 to convert the request into a standard protocol, for example a TCP/IP protocol. The request is then communicated to the APPN 18 where the request is passed through a second SOAP layer 38 and second protocol layer 42 to convert the request to a protocol used by the APPN 18. A response is communicated from the APPN 18 to the MPCS 14 in the reverse order. That is, the response is passed through the second SOAP and protocol layers 38 and 42 to convert the response into the standard protocol, e.g. TCP/IP. The response is then communicated to the MPCS 14 where the response is passed through the first SOAP and protocol layers 30 and 34 to convert the response to a protocol used by the MPCS 14.

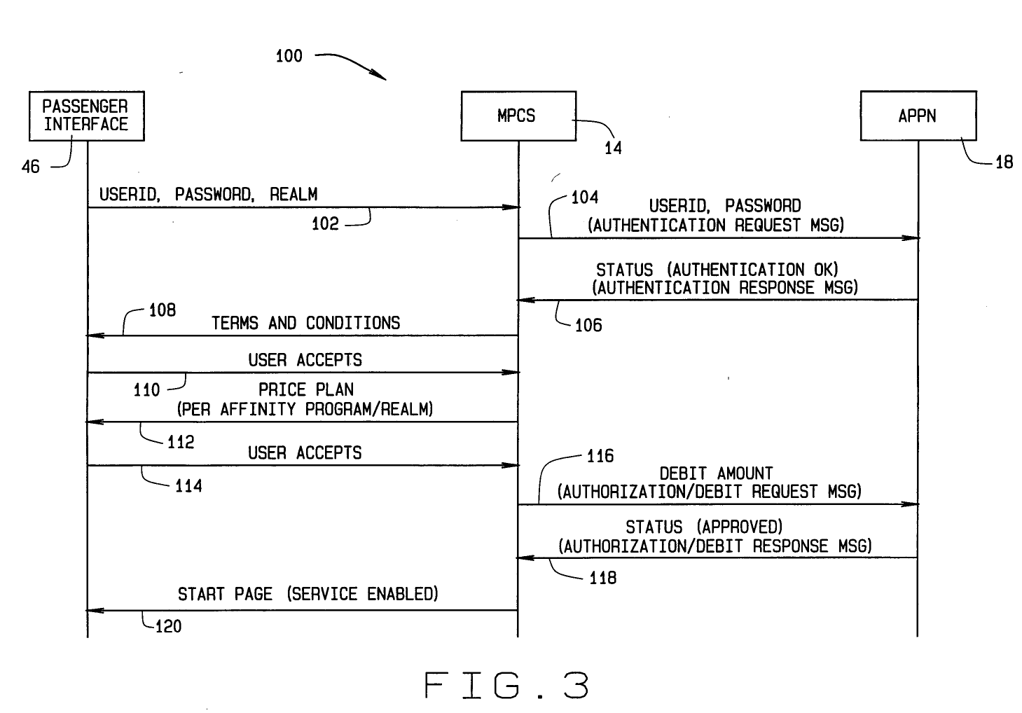

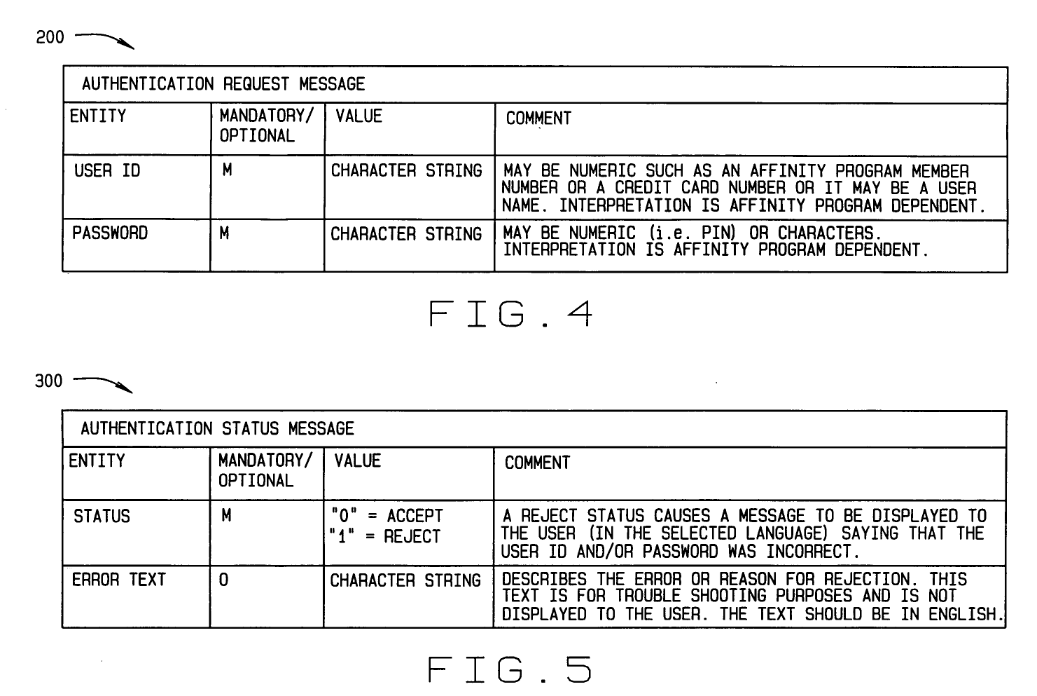

FIG. 3 is a sequence diagram 100 illustrating a sequence of data flows between a mobile platform passenger interface 46, the MPCS 14 and the APPN 18. The passenger interface 46 can be any computing device suitable for a passenger to enter data or information and view any sort of graphical image or data representations sent to the passenger interface 46. For example, the passenger interface 46 can be a lap top computer, a personal data assistant, a hand held computing device, or an input device and display installed in the mobile platform. In a preferred embodiment, when a passenger connects a user interface device 46 to the MPCS 14, via an on-board local area network (not shown), a mobile platform home web page is sent to the passenger interface 46. Via data entry fields, drop-down menus and links, the passenger enters a UserID and Password and selects a realm indicating his/her desire to pay for access to services provided by the MPCS 14 using affinity program award points. An access request message containing the passenger UserID, Password and selected realm is communicated to the MPCS 14 as indicated at 102.

The MPCS 14 recognizes the access request message as requesting to pay for access to the MPCS services using the passenger's affinity program award points. The MPCS 14 then communicates an authentication request message containing the passenger's UserID and password to the APPN 18 requesting verification that the passenger is an affinity program member, as indicated at 104. More specifically, the MPCS 14 communicates the authentication request message to the authentication Web service implemented by the APPN 18. FIG. 4 is a table 200 showing exemplary attributes that are included in the authentication request message.

The authentication Web service then communicates an authentication status message to the MPCS 14, as indicated at 106. The authentication status message indicates whether the passenger has been authenticated as a member of the affinity program. FIG. 5 is a table 300 showing exemplary attributes that are included in the authentication status message. Preferably, communication between the MPCS 14 and the authentication Web service, i.e. APPN 18, is implemented utilizing SOAP and WSDL, as described above.

In a preferred implementation, if the passenger is authenticated as an affinity program member, the MPCS 14 communicates a terms and conditions message to the passenger interface 46, as indicated at 108. The terms and conditions message displays the terms and conditions for use of the MPCS services. Alternatively, the communication of the terms and condition message can be skipped. If the terms and conditions message is implemented and the passenger indicates that the terms and conditions are accepted, a terms and conditions acceptance message is communicated to the MPCS 14, as indicated at 110. The MPCS 14 then communicates a price plan message to the passenger interface 46, as indicated at 112. The price plan message displays a designated amount of affinity program award points that the passenger is required to pay for access to the MPCS services. In one embodiment, the price plan information is retrieved from electronic storage (not shown) of the MPCS 14.

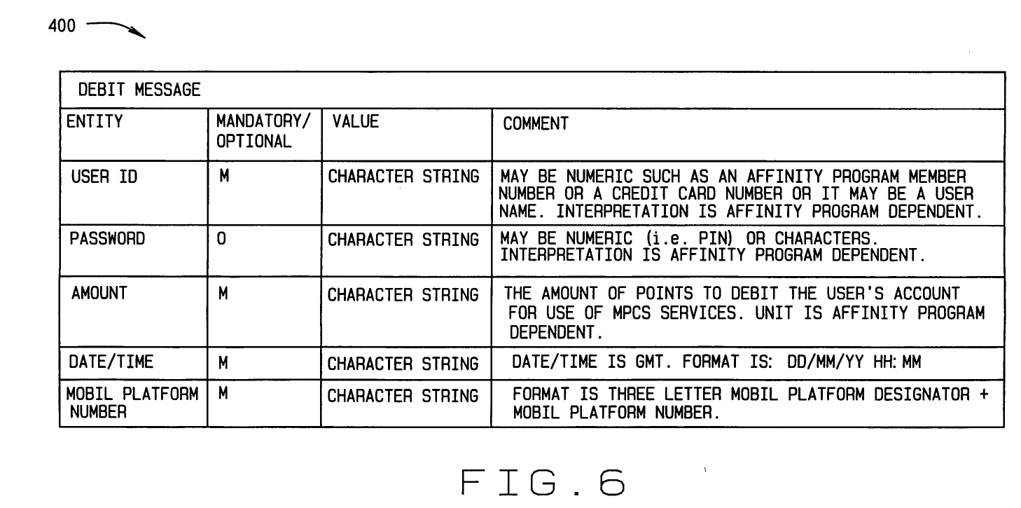

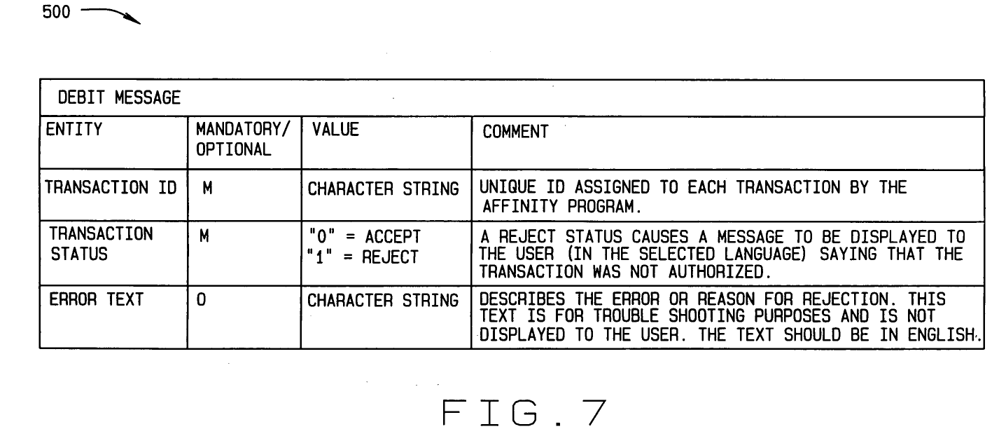

If the passenger indicates, via the passenger interface 46, that he/she agrees to pay the designated amount of affinity program award points, a price plan acceptance message is communicated to the MPCS 14, as indicated at 114. The MPCS 14 then communicates a debit authorization message to the APPN 18 requesting authorization for an affinity program award points account of the affinity program member to be debited the designated amount of affinity award points, as indicated at 116. More specifically, the MPCS 14 communicates the debit authorization request message to the debit authorization Web service implemented by the APPN 18. FIG. 6 is a table 400 showing exemplary attributes that are included in the debit authorization request message.

The debit authorization Web service verifies whether the affinity program member, i.e. the passenger, has an appropriate amount of award points in his/her award points account and is therefore authorized to use affinity program award points to pay for accessing the MPCS services. The debit authorization Web service then communicates a debit authorization status message to the MPCS 14 indicating whether the affinity program member is authorized to pay for accessing the MPCS services using affinity program award points, as indicated at 118. FIG. 7 is a table 500 showing exemplary attributes that are included in the authorization status message. Preferably, communication between the MPCS 14 and the debit authorization Web service, i.e. APPN 18, is implemented utilizing SOAP and WSDL, as described above.

If the member is authorized to pay for the MPCS services using affinity program award points, the MPCS 14 communicates a start page to the passenger interface 46 that enable the passenger to access the MPCS services, as indicated at 120.

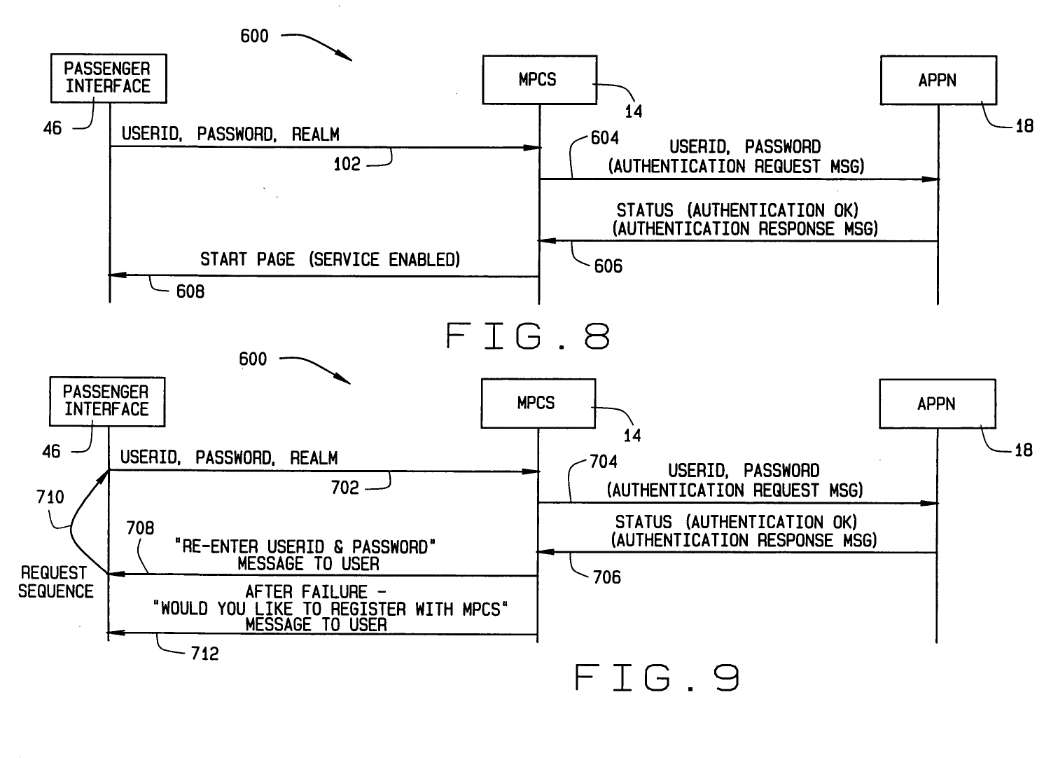

In a preferred embodiment, once the passenger, i.e. affinity program member, is authenticated and authorized to use affinity program award points to pay for the MPCS services, the price plan and debit authentication are valid for the entire trip. That is, the passenger may logon and logoff any number of times during the trip and not have to obtain debit authorization again. FIG. 8 is a sequence diagram 600 illustrating data flow between the mobile platform passenger interface 46, the MPCS 14 and the APPN 18 when a passenger wishes to re-logon to the MPCS 14. Via data entry fields, drop-down menus and links, the passenger enters his/her UserID and Password and selects a realm indicating a desire to logon onto the MPCS 14 for access to services provided by the MPCS 14. A login request message containing the passenger UserID, Password and selected realm is communicated to the MPCS 14, as indicated at 602.

The MPCS 14 recognizes the login request message and communicates an authentication request message containing the passenger's UserID and password to the authentication Web service requesting verification that the passenger attempting to login is a previously authenticated and authorized affinity program member, as indicated at 604. The authentication Web service then communicates an authentication status message to the MPCS 14, as indicated at 606. The authentication status message indicates whether the passenger has previously been authenticated as a member of the affinity program authorized to use affinity program award point to pay for access to the MPCS services. If the passenger is re-authenticated as an affinity program member, the MPCS 14 communicates the start page to the passenger interface 46, as indicated at 608.

Referring again to FIG. 1, when the authentication status message at 106 indicates that the authentication Web service denied authentication, the passenger receives a message from the MPCS 14 indicating that the passenger should re-attempt to obtain authentication. In a preferred implementation, if the authentication Web service denies authentication three times, the passenger receives a message from the MPCS 14 asking the passenger if he/she would like to access the MPCS services using a different form of payment, e.g. a credit card.

FIG. 9 is a sequence diagram 700 illustrating data flow between the mobile platform passenger interface 46, the MPCS 14 and the APPN 18 when the authentication Web service denies authentication of the passenger. As described in reference to FIG. 3, via data entry fields, drop-down menus and links, the passenger enters his/her UserID and Password and selects a realm indicating his/her desire to pay for access to the MPCS services using affinity program award points. The access request message containing the passenger UserID, Password and selected realm is communicated to the MPCS 14 as indicated at 702.

The MPCS 14 recognizes the access request message as requesting to pay for access to the services using the passenger's affinity program award points. The MPCS 14 then communicates the authentication request message containing the passenger's UserID and password to the authentication Web service, as indicated at 704. The authentication Web service then communicates an authentication status message to the MPCS 14, as indicated at 706. In this scenario, the authentication status message indicates the passenger is not authenticated as a member of the affinity program. A re-enter message is then communicated from the MPCS 14 to the passenger interface 46, as indicated at 708. The re-enter message displays a request for the passenger to re-enter their UserId and password. The access request message 702, the authentication request message 704 and the authentication status message 706 are then reiterated, as indicated at 710. In a preferred implementation, if the passenger is not authenticated by the authentication Web service after three attempts, the MPCS 14 communicates a registration inquiry message to the passenger interface 46, as indicated at 712. The registration inquiry message displays a message on the passenger interface 46 asking the passenger if he/she would like to access the MPCS services using a different form of payment, e.g. a credit card.

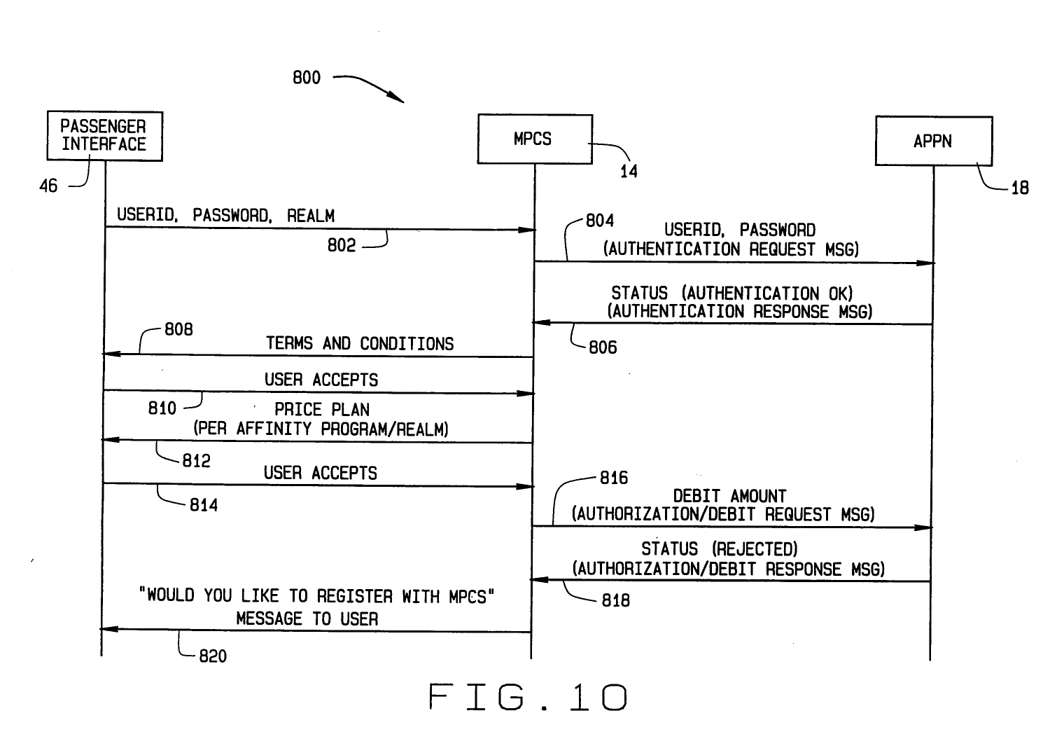

FIG. 10 is a sequence diagram 800 illustrating data flow between the mobile platform passenger interface 46, the MPCS 14 and the APPN 18 when the debit authorization Web service denies debit authorization of the affinity program member's award points account. The sequence diagram 800 includes data flows 802, 804, 806, 808, 810, 812, 814, 816 and 818 that are essentially the same as the data flows 102, 104, 106, 108, 110, 112, 114, 116 and 118 described above with reference to FIG. 3. The debit authorization status message returned from the debit authorization Web service at 818 indicates to the MPCS 14 that the affinity program member is not authorized to pay for accessing the MPCS services using affinity program award points. For example, the affinity program member does not have an adequate amount of affinity program award points in his/her account to pay for the MPCS services requested. In this instance, the MPCS 14 communicates a registration inquiry message to the passenger interface 46, as indicated at 820. The registration inquiry message displays a message on the passenger interface 46 asking the affinity program member if he/she would like to access the MPCS services using a different form of payment, e.g. a credit card.

Additionally, the system 10 implements Web service architecture that addresses various security concerns such as confidentiality, authorization, data integrity and proof of origin. For example, in a preferred implementation, the interface between the MPCS 14 and the APPN 18 is unpublished such that the interface is not discoverable by parties other that the mobile platform carrier implementing the MPCS 14 and the affinity program provider providing the authentication and authorization web services. Additionally, since the mobile platform carrier and the affinity program provider are known to each other, the HTTPS protocol is used. Furthermore, mutual authentication with security certificates, e.g. X.509 certificates, is implemented.

Thus, the system 10 provides a Web service interface between the MPCS 14 and the APPN 18 in a simple, yet powerful, way. This allows the mobile platform carrier to provide passengers access to the services provided by the MPCS 14 using their affinity program award points to pay for the access in a speedy and secure manner

While the invention has been described in terms of various specific embodiments, those skilled in the art will recognize that the invention can be practiced with modification within the spirit and scope of the claims.

What is claimed is:

1. A method for purchasing on-board services provided by a mobile platform carrier, said method comprising:
authenticating an affinity program member utilizing an affinity program authentication Web service, and
authorizing a debiting of an affinity program award points account of the affinity program member utilizing an affinity program debit authorization Web service.

2. The method of claim 1, wherein authenticating comprises:
communicating an authentication request message from user interface device to a mobile platform communication system; and
communicating the authentication request message from the mobile platform communication system to the affinity program authentication Web service.

3. The method of claim 2 wherein authenticating further comprises communicating an authentication status message from the affinity program authentication Web service to the mobile platform communication system.

4. The method of claim 3, wherein the method further comprises communicating a terms and conditions message from the mobile platform communication system to the user interface.

5. The method of claim 4, wherein the method further comprises communicating a price plan message from the mobile platform communication system to the user interface

6. The method of claim 1, wherein authorizing a debiting comprises communicating a debit authorization request message from the mobile platform communication system to the affinity program debit authorization Web service.

7. The method of claim 6, wherein authorizing a debiting further comprises communicating a debit authorization status message from the affinity program debit authorization Web service to the mobile platform communication system.

8. The method of claim 1, wherein the method further comprises communicating a service enablement message from the mobile platform communication system to the user interface.

9. A method for authorizing use of affinity program merit points to pay for access to services provided by a mobile platform communication system, said method comprising:
communicating an authentication request message from a mobile platform communication system to an affinity program authentication Web service requesting verification that a mobile platform passenger is an affinity program member;
communicating an authentication status message from the affinity program authentication Web service to the mobile platform communication system indicating whether the mobile platform passenger is an affinity program member;
communicating a debit authorization request message from the mobile platform communication system to an affinity program debit authorization Web service if the mobile platform passenger is verified to be an affinity program member, the debit authorization request message requesting authorization for the affinity program member to use affinity program award points to pay for accessing the services provided by the mobile platform communication system; and
communicating a debit authorization status message from the affinity program debit authorization Web service to the mobile platform communication system indicating whether the affinity program member is authorized to pay for accessing the services provided by the mobile platform communication system using affinity program award points.

10. The method of claim 9, wherein communicating the authentication request message comprises communicating an access request message from a user interface device to a mobile platform communication system requesting access to the services provided by the mobile platform communication system using affinity program award points.

11. The method of claim 9, wherein communicating the authentication request from the mobile platform communication system to the affinity program authentication Web service comprises utilizing simple object access protocol (SOAP) and Web service description language (WSDL) to communicate the authentication request.

12. The method of claim 9, wherein communicating the authentication status message from the affinity program authentication Web service to the mobile platform communication system comprises utilizing SOAP and WSDL to communicate the authentication status message.

13. The method of claim 9, wherein the method further comprises communicating a terms and conditions message from the mobile platform communication system to the user interface if the mobile platform passenger is verified to be an affinity program member, wherein the terms and conditions message requests the affinity program member to indicate whether a set of terms and conditions for use of services provided by the mobile platform communication system are accepted.

14. The method of claim 13, wherein the method further comprises communicating a price plan message from the mobile platform communication system to the user interface if the terms and conditions are accepted, wherein the price plan message requests the affinity program member to indicate whether the affinity program member agrees to pay a specified amount of affinity program award points for use of services provided by the mobile platform communication system.

15. The method of claim 14, wherein communicating the debit authorization request message from the mobile platform communication system to the affinity program debit authorization Web service, comprises communicating the debit authorization request message if the affinity program member agrees to pay a specified amount of affinity program award points.

16. The method of claim 9, wherein communicating a debit authorization request message from the mobile platform communication system to the affinity program debit authorization Web service comprises utilizing SOAP and WSDL to communicate the debit authorization request message.

17. The method of claim 9, wherein communicating a debit authorization status message from the affinity program debit authorization Web service to the mobile platform communication system comprises utilizing SOAP and WSDL to communicate the debit authorization status message.

18. The method of claim 9, wherein the method further comprises communicating a service enablement message from the mobile platform communication system to the user interface if the affinity program member is authorized to pay a specified amount of affinity program award points for use of the services provided by the mobile platform communication system, the service enablement message.

19. A system for authenticating an affinity program member and authorizing debiting an account of the affinity program member to pay for services provided on-board a mobile platform, said system comprising a mobile platform communication system configured to communicate with at least one mobile platform passenger interface; and
an affinity program provider Web service system configured to:
provide an affinity program authentication Web service for authenticating that a mobile platform passenger is an affinity program member upon receipt of an authentication request message from the mobile platform communication system; and
provide an affinity program debit authorization Web service for authorizing the affinity program member to use affinity program award points to pay for accessing services provided by the mobile platform communication system upon receipt of a debit authorization request message from the mobile platform communication system.

20. The system of claim 19, wherein the affinity program authentication Web service is configured to provide an authentication status message to the mobile platform communication system indicating whether the mobile platform passenger is an affinity program member.

21. The system of claim 19, wherein the affinity program debit authorization Web service is configured to provide a debit authorization status messaged to the mobile platform communication system indicating whether the affinity program member is authorized to pay for accessing the services provided by the mobile platform communication system using affinity program award points.

22. A method for completing an authentication and debit authorizing process for an affinity program member to use affinity program merit points to pay for access to services provided by a mobile platform communication system, said method comprising:
communicating an authentication request message from a passenger interface device to a mobile platform communication system;
communicating the authentication request message from the mobile platform communication system to an affinity program authentication Web service using simple object access protocol (SOAP) and Web service description language (WSDL), the authentication request message requesting verification that a mobile platform passenger is an affinity program member;
communicating an authentication status message from the affinity program authentication Web service to the mobile platform communication system utilizing SOAP and WSDL, the authentication status message indicating whether the mobile platform passenger is an affinity program member;
communicating a price plan message from the mobile platform communication system to the passenger interface, the price plan message requesting the affinity program member to indicate whether the affinity program member agrees to pay a specified amount of affinity program award points for use of the services provided by the mobile platform communication system;
communicating a debit authorization request message from the mobile platform communication system to the affinity program debit authorization Web service utilizing SOAP and WSDL if the affinity program member agrees to pay a specified amount of affinity program award points, the debit authorization request message requesting authorization for the affinity program member to use affinity program award points to pay for accessing the services provided by the mobile platform communication system; and
communicating a debit authorization status message from the affinity program debit authorization Web service to the mobile platform communication system utilizing SOAP and WSDL, the debit authorization status message indicating whether the affinity program member is authorized to pay for accessing the services provided by the mobile platform communication system using awards program merit points.
